(19) United States
(12) Patent Application Publication
(10) Pub. No.: US 2022/0050825 A1
(43) Pub. Date: Feb. 17, 2022

(54) BLOCK CHAIN BASED MANAGEMENT OF AUTO REGRESSIVE DATABASE RELATIONSHIPS

(71) Applicant: Bank of America Corporation, Charlotte, NC (US)

(72) Inventors: Suki Ramasamy, Chennai (IN); Thilaga Kannappan, Chennai (IN); Suganya Markandan, Tamil Nadu (IN); Kalpana Rajashekar, Chennai (IN); Anusha Balasubramanian, Chennai (IN); Vishnurupa N R, Thanjavur (IN); Deve Madhavan Nair, Chennai (IN)

(21) Appl. No.: 16/993,549

(22) Filed: Aug. 14, 2020

(51) Int. Cl. G06F 16/23; G06F 16/27; G06Q 40/00; G06Q 30/02; G06N 20/00; G06F 21/60

(52) U.S. Cl. CPC G06F 16/2379; G06F 16/27; G06Q 40/12; G06Q 2220/00; G06N 20/00; G06F 21/602; G06Q 30/0201

(57) ABSTRACT

Aspects of the disclosure relate to blockchain based management of auto regressive database relationships for a software application. A computing platform may retrieve, by a computing device and from one or more transaction processing systems, a data field associated with a transaction performed by a customer. A relationship between the data field and the customer may be identified based on a repository of historical transaction data. One or more ledgers of a distributed ledger system to be potentially updated may be identified. Then, the computing platform may determine whether the one or more identified ledgers are to be updated. Based upon a determination that the one or more identified ledgers are to be updated, the computing platform may provide, to the one or more identified ledgers, the data field. Then, the computing platform may cause the one or more identified ledgers to be updated.

### BACKGROUND

Aspects of the disclosure relate to deploying digital data processing systems to identify and update data relationships. In particular, one or more aspects of the disclosure relate to blockchain based management of auto regressive database relationships.

Enterprise organizations may utilize various platforms in a computing infrastructure to support various customer transactions. In some instances, a record of such transactions may be stored in a distributed ledger system. Ensuring that relationships among data fields associated with transactions are properly identified, and timely and targeted data updates of the distributed ledger system are performed may be of high significance to ensure a smooth running of the platforms, and to minimize errors. Accordingly, it may be highly advantageous to maintain efficient and stable platforms with continuously updated data relationships. In many instances, however, it may be difficult to identify relationships among the data fields associated with transactions, and update the distributed ledger system with speed and accuracy while also attempting to optimize network resources, bandwidth utilization, and efficient operations of the computing infrastructure.

### SUMMARY

Aspects of the disclosure provide effective, efficient, scalable, fast, reliable, and convenient technical solutions that address and overcome the technical problems associated with blockchain based management of auto regressive database relationships.

In accordance with one or more embodiments, a computing platform having at least one processor, and memory storing computer-readable instructions that, when executed by the at least one processor, cause the computing platform to retrieve, by a computing device and from one or more transaction processing systems, a data field associated with a transaction performed by a customer. Subsequently, the computing platform may identify, by the computing device and based on a repository of historical transaction data, a relationship between the data field and the customer. Then, the computing platform may identify, by the computing device and based on the relationship and the data field, one or more ledgers of a distributed ledger system to be potentially updated with the data field. Then, the computing platform may determine, based on a comparison with data in the repository of historical transaction data, whether the one or more identified ledgers are to be updated with the data field. Subsequently, the computing platform may, based upon a determination that the one or more identified ledgers are to be updated, provide, by the computing device and to the one or more identified ledgers, the data field. Then, the computing platform may cause, by the computing device, the one or more identified ledgers to be updated.

In some embodiments, the computing platform may retrieve data from ledgers of the distributed ledger system. Then, the computing platform may determine interrelationships in the retrieved data. Subsequently, the computing platform may store the interrelationships in the repository of historical transaction data. In some embodiments, the computing platform may determine the interrelationships in the retrieved data based on a machine learning model, where the machine learning model is trained to detect patterns in known interrelationships in the repository of historical transaction data.

In some embodiments, the computing platform may receive data from the one or more transaction processing systems. Then, the computing platform may determine interrelationships in the received data. Subsequently, the computing platform may store the interrelationships in the repository of historical transaction data. In some embodiments, the computing platform may determine the interrelationships in the received data based on a machine learning model, where the machine learning model is trained to detect patterns in known interrelationships in the repository of historical transaction data.

In some embodiments, the computing platform may determine, based on the comparison with data in the repository of historical transaction data, whether the data field is associated with the customer in the distributed ledger system. Then, the computing platform may, upon a determination that the data field is not associated with the customer, identify a ledger of the distributed ledger system that needs to be updated, where providing the data field may include providing the data field to the identified ledger. In some embodiments, the computing platform may cause, for the data field, a column to be created in the identified ledger. Then, the computing platform may enter, in a row corresponding to the customer and in the column corresponding to the data field, a value for the data field.

In some embodiments, the computing platform may detect a new ledger in the distributed ledger system. Then, the computing platform may retrieve data from the detected ledger. Subsequently, the computing platform may determine interrelationships in the retrieved data based on a machine learning model, wherein the machine learning model is trained to detect patterns in known interrelationships in the repository of historical transaction data.

In some embodiments, the computing platform may determine, by the computing device and for the one or more identified ledgers, a format for the data field, and where providing the data field comprises converting the data field to the determined format. In some embodiments, the format may be an encrypted format, and the computing platform may convert the data field to the encrypted format.

In some embodiments, the computing platform may train a machine learning model to identify the relationship between the data field and the customer.

In some embodiments, the computing platform may compare the data field to data for the customer. Then, the computing platform may determine a confidence score for the comparing. Subsequently, the computing platform may, upon a determination that the confidence score exceeds a first threshold, associate the data field to the customer.

In some embodiments, the computing platform may identify a link potentially impacted by the change. Then, the computing platform may determine, for the identified link, a link visit score indicative of a number of times the identified link is traversed in the production environment, where the visual highlighting of the identified link may be based on the link visit score. In some embodiments, the computing platform may, upon a determination that the confidence score does not exceed a second threshold, not associate the data field to the customer.

In some embodiments, the computing platform may identify the one or more ledgers of the distributed ledger system by applying a statistical decision making algorithm.

These features, along with many others, are discussed in greater detail below.

### BRIEF DESCRIPTION OF THE DRAWINGS

The present disclosure is illustrated by way of example and not limited in the accompanying figures in which like reference numerals indicate similar elements and in which:

FIGS. 1A and 1B depict an illustrative computing environment for blockchain based management of auto regressive database relationships;

FIG. 2 depicts an illustrative architecture for blockchain based management of auto regressive database relationships; and

FIG. 3 depicts another illustrative method for blockchain based management of auto regressive database relationships.

### DETAILED DESCRIPTION

In the following description of various illustrative embodiments, reference is made to the accompanying drawings, which form a part hereof, and in which is shown, by way of illustration, various embodiments in which aspects of the disclosure may be practiced. It is to be understood that other embodiments may be utilized, and structural and functional modifications may be made, without departing from the scope of the present disclosure.

It is noted that various connections between elements are discussed in the following description. It is noted that these connections are general and, unless specified otherwise, may be direct or indirect, wired or wireless, and that the specification is not intended to be limiting in this respect.

Organizations may host platforms to enable transactions. Generally, it may be of significant importance for an enterprise to keep such platforms running smoothly. Such platforms may generate a high volume of transactional data that may need to be stored. In some embodiments, such transactional data may need to be correlated with existing data to validate transactions. In some embodiments, transaction data may be stored in a distributed ledger system shared by a plurality of users and/or applications over a vast network of devices and nodes.

Generally, the transaction platforms may generate data in real-time over the array of networks. This is a vast volume of data that may be processed by the enterprise organization. Also, for example, a plurality of ledgers in the distributed ledger system may be updated in real-time by database users, and/or downstream applications. Such data may then be retrieved by the enterprise organization over the array of network devices and nodes. Accordingly, there is a need for all this data to be processed, analyzed, correlated, indexed, stored, and/or updated in near real-time, so as to validate and record transactions accurately.

As described herein, transaction data from transaction platforms and data recorded in the distributed ledger system may be analyzed to determine relationships in the data. In some embodiments, missing features of data may be identified. For example, one transaction may provide an address of a customer, and a second transaction may provide a postal code for the customer. Although the address of the customer may be recorded in the distributed ledger system, the postal code may be missing. Accordingly, as described herein, missing data fields may be identified, and may be uploaded onto the distributed ledger system. In some embodiments, a format of the data may be determined. In some instances, a ledger of the distributed ledger system may be modified by adding, and/or deleting data fields. Performing such activities in a dynamic environment where data is being generated and transmitted in near real-time by a plurality of parties, may be a challenge.

Accordingly, the techniques disclosed herein provide a solution to a problem arising in the realm of computer networks, and the solution is rooted in technology. Also, for example, the architecture and processes described herein may perform parallel computations, and by effectively utilizing machine learning models and decision making algorithms, considerably improve a performance of a computing system that manages database relationships. In generally, it may not be feasible to identify interrelationships between data in such a dynamic environment, and update a vast array of ledgers.

Accordingly, it may be of high significance for an enterprise organization to devise ways in which to automatically identify interrelationships between transactions, customers, and transaction data, identify missing data fields, identify ledgers that may need to be updated, and create an effective, actionable data upload strategy with speed and accuracy.

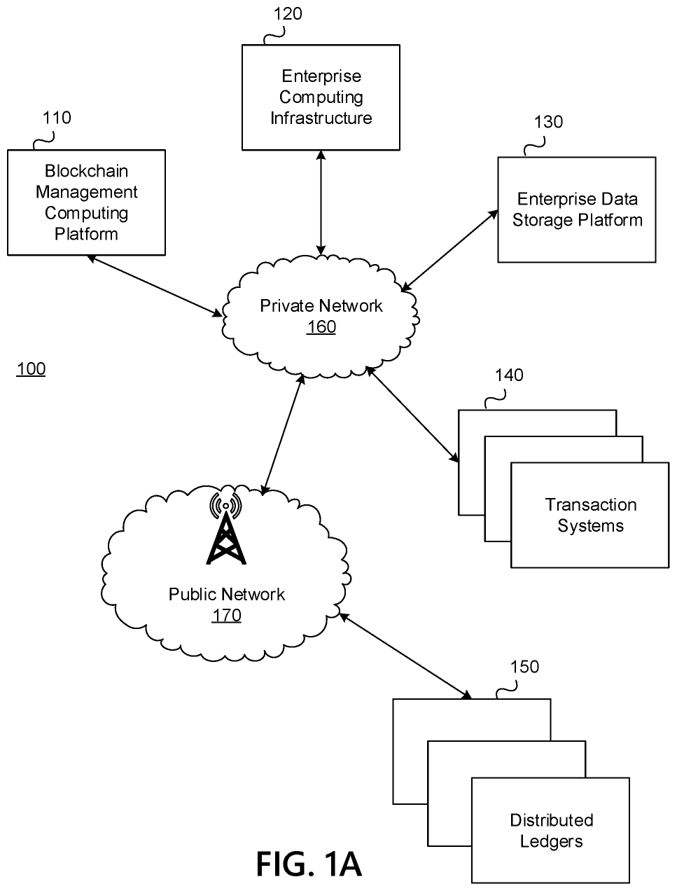

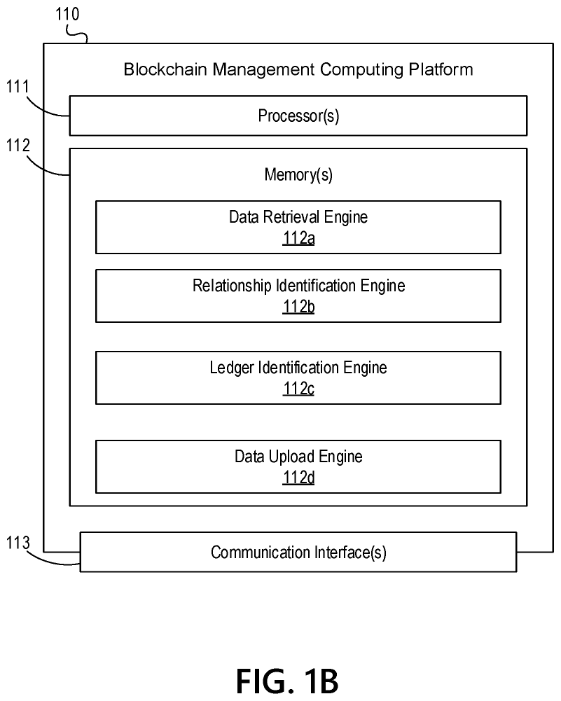

FIGS. 1A and 1B depict an illustrative computing environment for blockchain based management of auto regressive database relationships. Referring to FIG. 1A, computing environment 100 may include one or more computer systems. For example, computing environment 100 may include a blockchain management computing platform 110, enterprise computing infrastructure 120, an enterprise data storage platform 130, transaction systems 140, and distributed ledgers 150.

As illustrated in greater detail below, blockchain management computing platform 110 may include one or more computing devices configured to perform one or more of the functions described herein. For example, blockchain management computing platform 110 may include one or more computers (e.g., laptop computers, desktop computers, servers, server blades, or the like) and/or other computer components (e.g., processors, memories, communication interfaces).

Enterprise computing infrastructure 120 may include one or more computing devices and/or other computer components (e.g., processors, memories, communication interfaces). In addition, enterprise computing infrastructure 120 may be configured to host, execute, and/or otherwise provide one or more applications. For example, enterprise computing infrastructure 120 may be configured to host, execute, and/or otherwise provide one or more applications, such as, for example, banking applications, trading applications, mortgage applications, business loan applications, and/or other applications associated with an enterprise organization. In some instances, enterprise computing infrastructure 120 may be configured to provide various enterprise and/or back-office computing functions for an enterprise organization. For example, enterprise computing infrastructure 120 may include various servers and/or databases that store and/or otherwise maintain business information, information associated with business processes, and so forth. In addition, enterprise computing infrastructure 120 may process and/or otherwise execute actions based on scripts, commands and/or other information received from other computer systems included in computing environment 100. Additionally or alternatively, enterprise computing infrastructure 120 may receive instructions from blockchain management computing platform 110 and execute the instructions in a timely manner.

Enterprise data storage platform 130 may include one or more computing devices and/or other computer components (e.g., processors, memories, communication interfaces). In addition, and as illustrated in greater detail below, enterprise data storage platform 130 may be configured to store and/or otherwise maintain enterprise data. For example, enterprise data storage platform 130 may be configured to store and/or otherwise maintain data associated with transactions, data associated with distributed ledgers, and so forth. Additionally or alternatively, enterprise computing infrastructure 120 may load data from enterprise data storage platform 130, manipulate and/or otherwise process such data, and return modified data and/or other data to enterprise data storage platform 130 and/or to other computer systems included in computing environment 100.

Transaction systems 140 may include one or more computing devices and/or other computer components (e.g., processors, memories, communication interfaces) that facilitate various transactions, such as, for example, trading related transactions, mortgage related transactions, banking transactions, and so forth.

Distributed ledgers 150 may include one or more computing devices and/or other computer components (e.g., processors, memories, communication interfaces) that are components of a distributed ledger system. Generally, a distributed ledger may be a database that is shared and synchronized across multiple nodes in a network of computing devices. For example, distributed ledgers 150 may be a data structure that batches data into blocks of transaction, such as, for example, a blockchain. In some instances, the blocks may be hashed and the batched data may be verified.

Computing environment 100 also may include one or more networks, which may interconnect one or more of blockchain management computing platform 110, enterprise computing infrastructure 120, enterprise data storage platform 130, transaction systems 140, and/or distributed ledgers 150. For example, computing environment 100 may include a private network 160 (which may, e.g., interconnect blockchain management computing platform 110, enterprise computing infrastructure 120, enterprise data storage platform 130, transaction systems 140, and/or one or more other systems which may be associated with an organization, and public network 170 (which may, e.g., interconnect distributed ledgers 150 with private network 160 and/or one or more other systems, public networks, sub-networks, and/or the like). Public network 170 may be a cellular network, including a high generation cellular network, such as, for example, a 5G or higher cellular network. In some embodiments, private network 160 may likewise be a high generation cellular enterprise network, such as, for example, a 5G or higher cellular network.

In one or more arrangements, enterprise computing infrastructure 120, enterprise data storage platform 130, transaction systems 140, distributed ledgers 150, and/or the other systems included in computing environment 100 may be any type of computing device capable of receiving input via a user interface, and communicating the received input to one or more other computing devices. For example, enterprise computing infrastructure 120, enterprise data storage platform 130, transaction systems 140, distributed ledgers 150, and/or the other systems included in computing environment 100 may, in some instances, be and/or include server computers, desktop computers, laptop computers, tablet computers, smart phones, or the like that may include one or more processors, memories, communication interfaces, storage devices, and/or other components. As noted above, and as illustrated in greater detail below, any and/or all of blockchain management computing platform 110, enterprise computing infrastructure 120, enterprise data storage platform 130, transaction systems 140, and/or distributed ledgers 150, may, in some instances, be special-purpose computing devices configured to perform specific functions.

Referring to FIG. 1B, blockchain management computing platform 110 may include one or more processors 111, memory 112, and communication interface 113. A data bus may interconnect processor 111, memory 112, and communication interface 113. Communication interface 113 may be a network interface configured to support communication between blockchain management computing platform 110 and one or more networks (e.g., network 160, network 170, a local network, or the like). Memory 112 may include one or more program modules having instructions that when executed by processor 111 cause blockchain management computing platform 110 to perform one or more functions described herein and/or one or more databases that may store and/or otherwise maintain information which may be used by such program modules and/or processor 111. In some instances, the one or more program modules and/or databases may be stored by and/or maintained in different memory units of blockchain management computing platform 110 and/or by different computing devices that may form and/or otherwise make up blockchain management computing platform 110. For example, memory 112 may have, store, and/or include a data retrieval engine 112a, a relationship identification engine 112b, a ledger identification engine 112c, and a data upload engine 112d.

Data retrieval engine 112a may have instructions that direct and/or cause blockchain management computing platform 110 to retrieve, by a computing device and from one or more transaction processing systems, a data field associated with a transaction performed by a customer. In some embodiments, data retrieval engine 112a may have instructions that direct and/or cause blockchain management computing platform 110 to retrieve data from ledgers of the distributed ledger system.

Relationship identification engine 112b may have instructions that direct and/or cause blockchain management computing platform 110 to identify, by the computing device and based on a repository of historical transaction data, a relationship between the data field and the customer. In some embodiments, relationship identification engine 112b may have instructions that direct and/or cause blockchain management computing platform 110 to determine interrelationships in the data retrieved from the ledgers of the distributed ledger system.

Ledger identification engine 112c may have instructions that direct and/or cause blockchain management computing platform 110 to identify, by the computing device and based on the relationship and the data field, one or more ledgers of a distributed ledger system to be potentially updated with the data field.

Data upload engine 112d may have instructions that direct and/or cause blockchain management computing platform 110 to determine, based on a comparison with data in the repository of historical transaction data, whether the one or more identified ledgers are to be updated with the data field. In some embodiments, data upload engine 112d may have instructions that direct and/or cause blockchain management computing platform 110 to cause, by the computing device, the one or more identified ledgers to be updated.

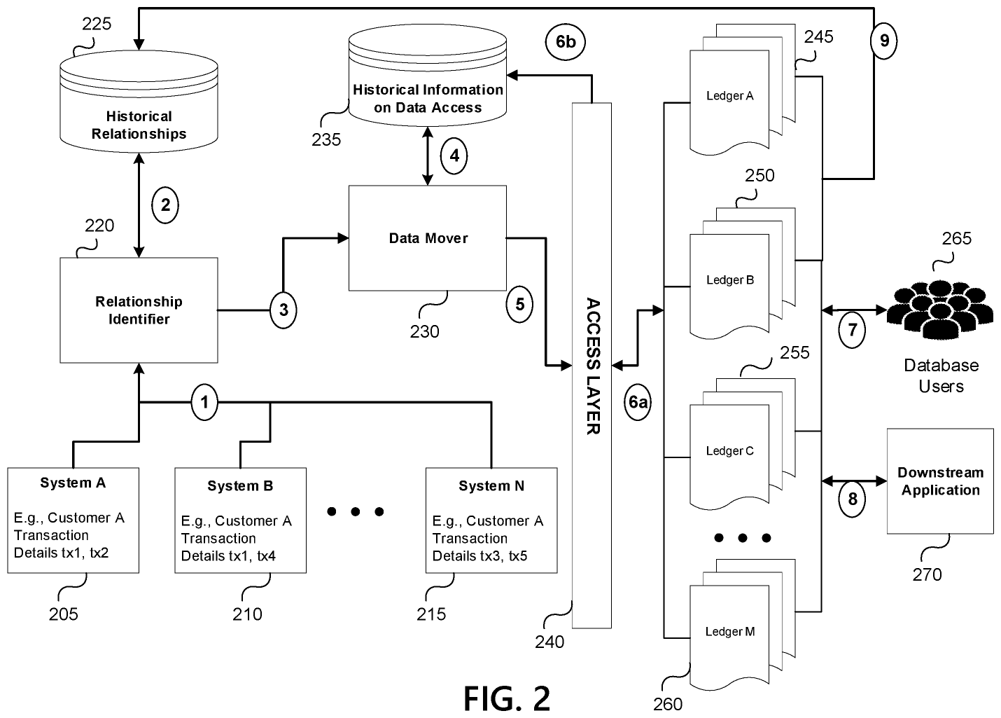

FIG. 2 depicts an illustrative architecture for blockchain based management of auto regressive database relationships. Referring to FIG. 2, at step 1, blockchain management computing platform 110 may retrieve, by a computing device and from one or more transaction processing systems, a data field associated with a transaction performed by a customer. For example, blockchain management computing platform 110 may be communicatively linked, via a network, to one or more transaction processing systems, such as, for example, System A 205, System B 210, . . . , and System N 215. Such systems may be, for example, platforms that facilitate transactions. In some instances, a transaction performed by the one or more transaction processing systems may include details of the transaction. The details of the transaction may include personal data associated with the parties to the transaction, such as, for example, a name, an address, a postal code, a social security number, a date of the transaction, an amount transacted, and so forth.

For example, System A 205 may be a trading platform where a customer may be able to execute trading related transactions. In some instances, a transaction performed via System A 205 may include details of the transaction, such as, for example, tx1 and tx2. As another example, System B 210 may be a loan processing platform, and a transaction performed via System B 210 may include details of the transaction, such as, for example, tx1 and tx4. Also, for example, System N 215 may be a banking platform, and a transaction performed via System N 215 may include details of the transaction, such as, for example, tx3 and tx5.

In some embodiments, tx1, tx2, tx5 may be associated with an individual customer, and/or a group of customers. As indicated, blockchain management computing platform 110 may retrieve transaction details tx1 and tx2 from System A 205, tx1 and tx4 from System B 210, and tx3 and tx5 from System N 215. For example, tx1 may be a name of the customer, tx2 may be an address of the customer, tx3 may be a postal code associated with the address of the customer, tx4 may be a social security number of the customer, and tx5 may be an age of the customer.

In some embodiments, at step 2, blockchain management computing platform 110 may identify, by the computing device and based on a repository of historical transaction data, a relationship between the data field and the customer. For example, relationship identifier 220 may retrieve data on interrelationships from a database of historical relationships 225. Generally, the database of historical relationships 225 may store data that associates customers, transactions, and transaction details. In some embodiments, the database of historical relationships 225 may receive such associations from the relationship identifier 220. For example, relationship identifier 220 may have identified one or more features of customer data from prior transactions and stored such data in database of historical relationships 225.

As described herein, tx1 may be a name of a customer, say Customer A, and relationship identifier 220 may store the association between Customer A and the name in the database of historical relationships 225. Also, for example, tx2 may be an address of the customer, and relationship identifier 220 may store the association between Customer A and the address in the database of historical relationships 225. In some embodiments, blockchain management computing platform 110 may retrieve a data field from System B 210. For example, blockchain management computing platform 110 may retrieve tx1, and tx4, which may be a social security number. Accordingly, relationship identifier 220 may access the database of historical relationships 225 to identify that tx1 (e.g., name of Customer A) and tx2 (e.g., address of the customer), are associated with Customer A. Accordingly, blockchain management computing platform 110 (e.g., relationship identifier 220) may associate tx4 with tx1 and tx2. Accordingly, Customer A may now be associated with a name, an address, and a social security number.

In some examples, blockchain management computing platform 110 may have retrieved the customer data from the distributed ledger system and stored it in the database of historical relationships 225. For example, the database of historical relationships 225 may receive such associations from the distributed ledger system (for example, at step 9). For example, as data in the ledgers are updated and/or modified by various parties, such as, for example, database users 265 (via, for example, step 7), and/or downstream applications 270 (via, for example, step 8), such information may be retrieved by blockchain management computing platform 110 at step 9, and stored in the database of historical relationships 225. For example, at step 9, blockchain management computing platform 110 may retrieve data from ledgers of the distributed ledger system, and may determine interrelationships in the retrieved data. In some embodiments, blockchain management computing platform 110 may store the interrelationships in the repository of historical transaction data, such as, for example, the database for historical relationships 225.

In some embodiments, at step 9, blockchain management computing platform 110 may detect a new ledger in the distributed ledger system. Then, blockchain management computing platform 110 may retrieve data from the detected ledger. Subsequently, blockchain management computing platform 110 may determine interrelationships in the retrieved data based on a machine learning model, wherein the machine learning model is trained to detect patterns in known interrelationships in the repository of historical transaction data. Similarly, at step 1, blockchain management computing platform 110 may receive data from the one or more transaction processing systems. Then, blockchain management computing platform 110 may determine interrelationships in the received data. Subsequently, at step 2, blockchain management computing platform 110 may store the interrelationships in the repository of historical transaction data, such as, for example, the database for historical relationships 225.

In some embodiments, blockchain management computing platform 110 may train a machine learning model to identify the interrelationships, where the machine learning model may be trained to detect patterns in known interrelationships in the repository of historical transaction data. For example, relationship identifier 220 may be configured to run clustering algorithms to classify the data retrieved from the one or more transaction processing systems. For example, a K-means clustering algorithm may be used to detect patterns among the retrieved data. In some embodiments, a logistic regression model may be applied to detect the patterns. For example, blockchain management computing platform 110 may deploy the machine learning model to detect patterns between data in the database of historical relationships 225, and identify new relationships based on such detected patterns.

Generally, the machine learning model may be trained to identify features such as, for example, types of data fields, types of data formats, types of transactions, an amount transacted, sources of transactions, parties in a transaction, and so forth. Accordingly, the machine learning model may be trained via supervised learning techniques, based on labeled data (e.g., historical data), to learn the associations between such features. For example, relationship identifier 220 may be configured to apply supervised learning techniques based on one or more of random forest, gradient boosted trees, support vector machines, neural networks, decision trees, and so forth. In some embodiments, the one or more data attributes (e.g., images customers) may include unstructured data. Accordingly, the machine learning model may be trained via a combination of supervised and semi-supervised learning techniques. For example, relationship identifier 220 may be configured to apply a supervised learning technique in combination with a clustering and/or dimensional reduction technique. For example, a k-means clustering and/or a principal component analysis technique may be utilized.

In some embodiments, blockchain management computing platform 110 may compare the data field to data for the customer. For example, relationship identifier 220 may be configured to compare the received data with the data stored in the database of historical relationships 225. For example, data fields {tx1, tx4} received from System B 210 may be compared to stored data fields {tx1, tx2} previously retrieved from System A 205. Accordingly, blockchain management computing platform 110 may determine that tx1 is a common data field with a 100% match. Based on such a determination, blockchain management computing platform 110 may associate tx1, tx2, and tx4 with Customer A, and store the association in the database of historical relationships 225.

As another example, data fields {tx3, tx5} received from System C 215 may be compared to stored data fields {tx1, tx2} previously retrieved from System A 205. Accordingly, blockchain management computing platform 110 may determine that there are no common data fields. Based on such a determination, blockchain management computing platform 110 may determine that data fields {tx3, tx5} received from System C 215 are new data fields associated with Customer A.

In some embodiments, blockchain management computing platform 110 may determine a confidence score for the comparing. Generally, the confidence score may indicate a strength of a relationship. For example, two pieces of information that are highly correlated may be associated with a high confidence score. Also, for example, two pieces of information that are not highly correlated may be associated with a low confidence score. For example, when blockchain management computing platform 110 compares a received data field to data for the customer, a 100% match may be indicative of a high confidence score.

In some instances, a match in a range of 90-100% may be associated with a high confidence score, a match in a range of 70-90% may be associated with a medium confidence score, and a match in a range of less than 70% may be associated with a low confidence score. Subsequently, upon a determination that the confidence score exceeds a first threshold (e.g., 90%), blockchain management computing platform 110 may associate the data field to the customer. For example, when an identified relationship is associated with a match of 95%, relationship identifier 220 may store the relationship in the database of historical relationships 225. In some embodiments, upon a determination that the confidence score does not exceed a second threshold (e.g., 70%), blockchain management computing platform 110 may not associate the data field to the customer. For example, when the identified relationship is associated with a match of 60%, relationship identifier 220 may not store the relationship in the database of historical relationships 225. In some instances, when the identified relationship is associated with a medium confidence score, relationship identifier 220 may apply additional tools to determine if a relationship exists. In some embodiments, in such situations, relationship identifier 220 may issue an alert notification to a human reviewer to review the received data field and determine if it is related to the stored data for the customer.

In some aspects, blockchain management computing platform 110 may determine the confidence level based on one or more similarity indices. For example, data fields may be represented as higher dimensional vectors, and one or more distance measures (e.g., Euclidean, Manhattan, Minkowski, and so forth) may be utilized to determine a distance between the vectors. In some embodiments, a Jaccard metric may be utilized to compare non-numerical features of data points. Additional and/or alternative measures of similarity may be utilized. In some embodiments, two data points that are close may be associated with a low similarity distance, and consequently a high confidence score indicative of a strong relationship. Also, for example, two data points that are far apart may be associated with a high similarity distance, and consequently a low confidence score indicative of a strong relationship.

In some embodiments, blockchain management computing platform 110 may determine, based on the comparison with data in the repository of historical transaction data, whether the data field is associated with the customer in the distributed ledger system. For example, as described herein, the database of historical relationships 225 may store information about relationships based on previous transactions. Also, for example, the previous transactions may be via the one or more transaction processing platforms (e.g., System A 205, System B 210, . . . , System N 215, and so forth), and/or data related to the previous transactions may be recorded in the distributed ledger system (e.g., Ledger A 245, Ledger B 250, Ledger C 255, . . . , Ledger M 260, and so forth). Accordingly, relationship identifier 220 may, at step 2, retrieve such stored relationship data from the database of historical relationships 225, and may compare the received data field to determine if there is an existing relationship with a customer.

In some embodiments, at step 3, blockchain management computing platform 110 may provide the data field and the relationship to data mover 230. The data mover 230 may be configured to receive the data field from the relationship identifier. In some embodiments, data mover 230 may determine additional attributes of the data field, and may match these attributes with rules and/or protocols applicable to the ledgers in the distributed ledger system.

In some embodiments, at step 6a, blockchain management computing platform 110 may retrieve data from ledgers of the distributed ledger system. In some embodiments, blockchain management computing platform 110 may identify rules for data access and/or upload. Generally, a distributed ledger system may be a database that is shared and synchronized across multiple nodes in a network of computing devices. For example, the distributed ledger system may include a plurality of ledgers, such as, for example, Ledger A 245, Ledger B 250, Ledger C 255, . . . , Ledger M 260, and so forth. Database users 265 may access, modify, validate, and/or otherwise manage data in the plurality of ledgers. As used herein, database users 265 may be individuals, corporate bodies, organizations, and so forth. Also, for example, one or more downstream applications 270 may access, modify, validate, and/or otherwise manage data in the plurality of ledgers.

A record of transactions may be stored in the plurality of ledgers. Generally, data stored on the distributed ledger system may be shared across multiple devices and/or nodes (e.g., on a peer-to-peer network). Devices and/or nodes may replicate and store an exact copy of a ledger of the plurality of ledgers. Also, for example, one or more rules and/or protocols may be applicable to the plurality of ledgers. For example, database users 265 may agree on a type of content that may be stored in the plurality of ledgers.

For example, the distributed ledger system may include a Proof of Work (PoW) protocol that prescribe rules for creating, broadcasting, and/or verifying ledgers on a network. Also, for example, the distributed ledger system may include a Proof of eXercise (PoX) protocol, Proof of Elapsed Time (PoET), Proof of Luck (PoL), Proof of Retrievability (PoR), and/or a Proof of Stake (PoS) protocol. In some embodiments, open source protocols, such as, for example, Ethereum, may be utilized by the distributed ledger system.

In some embodiments, access layer 240 may determine the rules and/or protocols applicable to Ledger A 245, Ledger B 250, Ledger C 255, . . . , Ledger M 260, and so forth. Such rules and/or protocols may determine a type of data that may be stored in Ledger A 245, Ledger B 250, Ledger C 255, . . . , Ledger M 260, a timing and/or a sequence in which data may be uploaded, a format for the data, and so forth. In some embodiments, at step 6b, blockchain management computing platform 110 may store the identified rules in a database for historical information on data access 235. For example, access layer 240 may identify the rules and protocols, and store them, at step 6b, in the database for historical information on data access 235.

In some embodiments, data mover 230 may, at step 4, retrieve the applicable rules and/or protocols from the database for historical information on data access 235. Accordingly, data mover 230 may determine attributes of the data field, and may match these attributes with the retrieved rules and/or protocols applicable to the ledgers in the distributed ledger system.

In some embodiments, blockchain management computing platform 110 may, upon a determination that the data field is not associated with the customer, identify a ledger of the distributed ledger system that needs to be updated. For example, as described herein, blockchain management computing platform 110 may determine that transaction details tx3 (e.g., postal code associated with the address of the customer) and tx5 (e.g., age of the customer), retrieved from System N 215 do not match with existing data stored in the database for historical relationships 225. Accordingly, relationship identifier 220 may determine that tx3 and tx5 are attributes that are not associated with Customer A. Since relationships identified in the plurality of ledgers are also stored in the database for historical relationships 225, a lack of a match may indicate that the plurality of ledgers do not include data fields tx3 and tx5 associated with Customer A. Based on the rules and/or protocols, blockchain management computing platform 110 may identify a ledger of the distributed ledger system that needs to be updated.

For example, at step 4, blockchain management computing platform 110 may identify, by the computing device and based on the relationship and the data field, one or more ledgers of a distributed ledger system to be potentially updated with the data field. In some instances, Ledger A 245 may be configured to store a first type of data, and Ledger B 250 may not be configured to store the first type of data. For example, Ledger A 245 may be configured to store personal information, whereas permissions for Ledger B 250 may not allow storage of personal information. Accordingly, blockchain management computing platform 110 may identify tx3 and tx5 to be personal data, and based on the protocols, determine that Ledger A 245 may be updated, but that Ledger B 250 may not be updated.

In some embodiments, blockchain management computing platform 110 may identify the one or more ledgers of the distributed ledger system by applying a statistical decision making algorithm. For example, data mover 230 may be configured to run a statistical decision making model. In some embodiments, rules and/or protocols associated with the plurality of ledgers may be retrieved from the database for historical information on data access 235, and may be input into the decision making model. Also, for example, parameters corresponding to the data field may be input into the decision making model. For example, data attributes, such as whether the data is numeric only, alphanumeric, encrypted, hashed, confidential data, personal data, payment card data, health information, and so forth, may be input into the decision making model. Based, on such protocols and parameters, the decision making model may identify the one or more ledgers of the distributed ledger system that may need to be updated with the data field.

In some embodiments, blockchain management computing platform 110 may determine, based on a comparison with data in the repository of historical transaction data, whether the one or more identified ledgers are to be updated with the data field. For example, data mover 230 may, at step 4, retrieve data from the database for historical information on data access 235 to determine whether the one or more identified ledgers are to be updated with the data field. For example, rules and/or protocols may have been updated. As another example, although rules and/or protocols may indicate that Ledger A 245 may be updated with the data field, data mover 230 may determine that one or more business rules of the enterprise organization may not allow Ledger A 245 to be updated with the data field. For example, data mover 230 may access a business rules engine that determines transfer of data across a firewall of the enterprise organization. For example, some data may be deemed to be proprietary for the enterprise organization, and accordingly, such data may not be uploaded to Ledger A 245.

In some embodiments, at step 5, blockchain management computing platform 110 may, based upon a determination that the one or more identified ledgers are to be updated, provide, by the computing device and to the one or more identified ledgers, the data field. For example, data mover 230 may move the data field via the access layer 240, and send the data field to the distributed ledger system.

In some embodiments, blockchain management computing platform 110 may determine, by the computing device and for the one or more identified ledgers, a format for the data field. For example, the data may be in a SPSS portable format, structured format, compressed format, encrypted format, or utilize common character encodings, such as, for example, ASCII, Unicode, and so forth. Also, for example, the data may be formatted as text, a script, XML form, HTML form, Plain Text, and so forth. As another example, the data may be in an audio format, a video format, an image format, a database structure, and so forth. In some embodiments, blockchain management computing platform 110 may determine a format in which the data may be stored in the identified ledger. For example, access layer 240 may determine a data format for the plurality of ledgers, and may store the format in database for historical information on data access 235. Accordingly, upon identifying the ledger that needs to be updated with the data field, data mover 230 may retrieve the data format protocol for the identified ledger.

In some aspects, blockchain management computing platform 110 may, at step 5, provide the data field by converting the data field to the determined format. For example, data mover 230 may, after determining the data format protocol for the identified ledger, convert the data field to the appropriate data format. For example, the format may be an encrypted format, and blockchain management computing platform 110 may convert the data field to the encrypted format. For example, data mover 230 may apply a hashing algorithm to the data field to encrypt the data field.

In some embodiments, at step 6a, blockchain management computing platform 110 may cause, by the computing device, the one or more identified ledgers to be updated. For example, data mover 230 may provide the data (in an appropriate format) and a list of the ledgers to be updated, to the access layer 240. In some embodiments, access layer 240 may generate a script based on the list of ledgers and the data field, and the script may be run to cause the one or more identified ledgers to be updated.

In some embodiments, at step 6a, blockchain management computing platform 110 may, upon a determination that the data field is not associated with the customer, cause, for the data field, a column to be created in the identified ledger. As described herein, blockchain management computing platform 110 may determine that transaction details tx3 and tx5 are not associated with Customer A in the plurality of ledgers. Accordingly, after receiving, from data mover 230, the list of ledgers that need to be updated with data fields for tx3 and/or tx5, access layer 240 may modify the identified ledgers. In some embodiments, the ledgers may store data in a tabular format, and access layer 240 may cause a column to be added to the tabular ledger, where the column corresponds to the data field to be added.

For example, data mover 230 may identify that Ledger A 245 may need to be updated with tx3 (e.g., postal code associated with the address of the customer). Accordingly, access layer 240 may cause a column corresponding to “Postal Code” to be created in the tabular database of Ledger A 245. Then, blockchain management computing platform 110 may enter, in a row corresponding to the customer and in the column corresponding to the data field, a value for the data field. For example, if the postal code associated with Customer A is “XXXXX-YYYY,” then access layer 240 may enter the value “XXXXX-YYYY” in a cell corresponding to the row for “Customer A” and the column for “Postal Code” in Ledger A 245.

As another example, data mover 230 may identify that Ledger C 255 may need to be updated with tx5 (e.g., age associated with the customer). Accordingly, access layer 240 may cause a column corresponding to “Age” to be created in the tabular database of Ledger C 255. Then, blockchain management computing platform 110 may enter, in a row corresponding to the customer and in the column corresponding to the data field, a value for the data field. For example, if the age associated with Customer A is “ZZ,” then access layer 240 may enter the value “ZZ” in a cell corresponding to the row for “Customer A” and the column for “Age” in Ledger C 255.

Generally, the one or more transaction platforms (e.g., System A 205, System B 210, . . . , System N 215) may be providing data in real-time over an array of networks. This is a vast volume of data that is received by blockchain management computing platform 110. Also, for example, the plurality of ledgers (e.g., Ledger A 245, Ledger B 250, Ledger C 255, . . . , Ledger M 260) may be updated in real-time by database users 265, and/or downstream applications 270. Such data may then be retrieved by blockchain management computing platform 110 over an array of network devices and nodes. Accordingly, there is a need for all this data to be processed, analyzed, correlated, indexed, stored, and/or updated in near real-time, so as to validate and record transactions accurately. Accordingly, the techniques disclosed herein provide a solution to a problem arising in the realm of computer networks, and the solution is rooted in technology. Also, for example, the architecture and processes described herein may perform parallel computations, and by effectively utilizing machine learning models and decision making algorithms, considerably improve a performance of a computing system that manages database relationships.

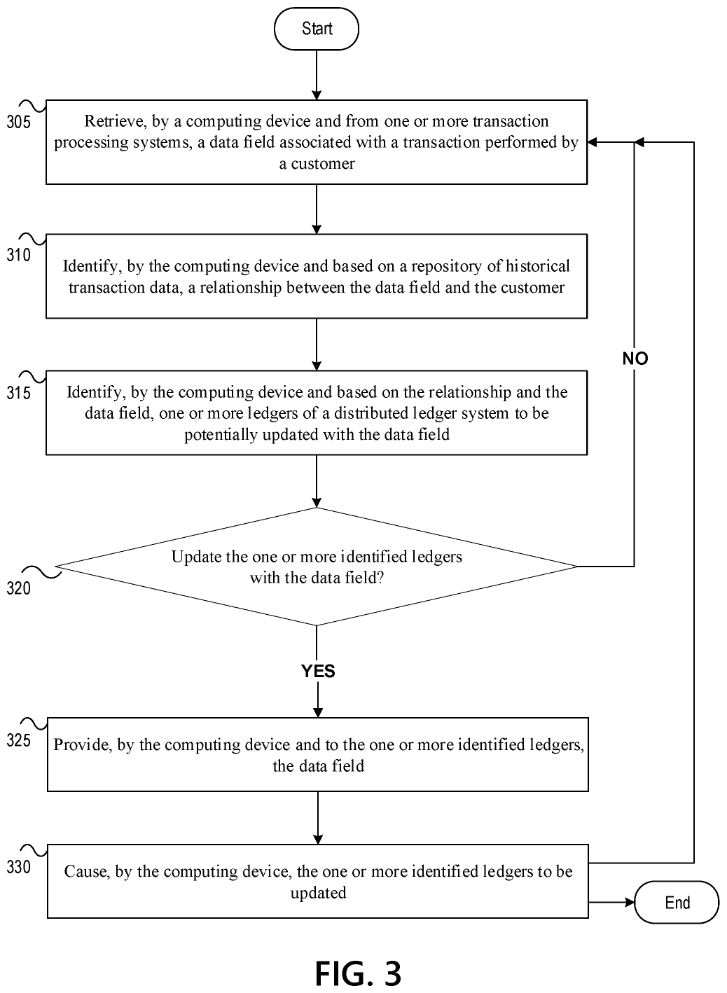

FIG. 3 depicts an illustrative method for machine learning based blockchain based management of auto regressive database relationships. Referring to FIG. 3, at step 305, a blockchain management computing platform 110, having at least one processor, and memory storing computer-readable instructions that, when executed by the at least one processor, cause blockchain management computing platform 110 to retrieve, by a computing device and from one or more transaction processing systems, a data field associated with a transaction performed by a customer. At step 310, blockchain management computing platform 110 may identify, by the computing device and based on a repository of historical transaction data, a relationship between the data field and the customer. At step 315, blockchain management computing platform 110 may identify, by the computing device and based on the relationship and the data field, one or more ledgers of a distributed ledger system to be potentially updated with the data field.

At step 320, blockchain management computing platform 110 may determine, based on a comparison with data in the repository of historical transaction data, whether the one or more identified ledgers are to be updated with the data field. Based upon a determination that the one or more identified ledgers are to not be updated, the process may return to step 305 to retrieve additional data fields from the one or more transaction systems.

At step 325, blockchain management computing platform 110 may, based upon a determination that the one or more identified ledgers are to be updated, provide, by the computing device and to the one or more identified ledgers, the data field. At step 330, blockchain management computing platform 110 may cause, by the computing device, the one or more identified ledgers to be updated. In some embodiments, the process may return to step 305 to retrieve additional data fields from the one or more transaction systems.

One or more aspects of the disclosure may be embodied in computer-usable data or computer-executable instructions, such as in one or more program modules, executed by one or more computers or other devices to perform the operations described herein. Generally, program modules include routines, programs, objects, components, data structures, and the like that perform particular time-sensitive tasks or implement particular abstract data types when executed by one or more processors in a computer or other data processing device. The computer-executable instructions may be stored as computer-readable instructions on a computer-readable medium such as a hard disk, optical disk, removable storage media, solid-state memory, RAM, and the like. The functionality of the program modules may be combined or distributed as desired in various embodiments. In addition, the functionality may be embodied in whole or in part in firmware or hardware equivalents, such as integrated circuits, application-specific integrated circuits (ASICs), field programmable gate arrays (FPGA), and the like. Particular data structures may be used to more effectively implement one or more aspects of the disclosure, and such data structures are contemplated to be within the scope of computer executable instructions and computer-usable data described herein.

Various aspects described herein may be embodied as a method, an apparatus, or as one or more computer-readable media storing computer-executable instructions. Accordingly, those aspects may take the form of an entirely hardware embodiment, an entirely software embodiment, an entirely firmware embodiment, or an embodiment combining software, hardware, and firmware aspects in any combination. In addition, various signals representing data or events as described herein may be transferred between a source and a destination in the form of light or electromagnetic waves traveling through signal-conducting media such as metal wires, optical fibers, or wireless transmission media (e.g., air or space). In general, the one or more computer-readable media may be and/or include one or more non-transitory computer-readable media.

As described herein, the various methods and acts may be operative across one or more computing servers and one or more networks. The functionality may be distributed in any manner, or may be located in a single computing device (e.g., a server, a client computer, and the like). For example, in alternative embodiments, one or more of the computing platforms discussed above may be combined into a single computing platform, and the various functions of each computing platform may be performed by the single computing platform. In such arrangements, any and/or all of the above-discussed communications between computing platforms may correspond to data being accessed, moved, modified, updated, and/or otherwise used by the single computing platform. Additionally or alternatively, one or more of the computing platforms discussed above may be implemented in one or more virtual machines that are provided by one or more physical computing devices. In such arrangements, the various functions of each computing platform may be performed by the one or more virtual machines, and any and/or all of the above-discussed communications between computing platforms may correspond to data being accessed, moved, modified, updated, and/or otherwise used by the one or more virtual machines.

Aspects of the disclosure have been described in terms of illustrative embodiments thereof. Numerous other embodiments, modifications, and variations within the scope and spirit of the appended claims will occur to persons of ordinary skill in the art from a review of this disclosure. For example, one or more of the steps depicted in the illustrative figures may be performed in other than the recited order, and one or more depicted steps may be optional in accordance with aspects of the disclosure.

What is claimed is:

1. A computing platform, comprising:
at least one processor; and
memory storing computer-readable instructions that, when executed by the at least one processor, cause the computing platform to:
retrieve, by a computing device and from one or more transaction processing systems, a data field associated with a transaction performed by a customer;
identify, by the computing device and based on a repository of historical transaction data, a relationship between the data field and the customer;
identify, by the computing device and based on the relationship and the data field, one or more ledgers of a distributed ledger system to be potentially updated with the data field;
determine, based on a comparison with data in the repository of historical transaction data, whether the one or more identified ledgers are to be updated with the data field;
based upon a determination that the one or more identified ledgers are to be updated, provide, by the computing device and to the one or more identified ledgers, the data field; and
cause, by the computing device, the one or more identified ledgers to be updated.

2. The computing platform of claim 1, wherein the instructions comprise additional computer-readable instructions that, when executed by the at least one processor, cause the computing platform to:
retrieve data from ledgers of the distributed ledger system;
determine interrelationships in the retrieved data; and
store the interrelationships in the repository of historical transaction data.

3. The computing platform of claim 2, wherein the instructions comprise additional computer-readable instructions that, when executed by the at least one processor, cause the computing platform to:
determine the interrelationships in the retrieved data based on a machine learning model, wherein the machine learning model is trained to detect patterns in known interrelationships in the repository of historical transaction data.

4. The computing platform of claim 1, wherein the instructions comprise additional computer-readable instructions that, when executed by the at least one processor, cause the computing platform to:
receive data from the one or more transaction processing systems;
determine interrelationships in the received data; and
store the interrelationships in the repository of historical transaction data.

5. The computing platform of claim 4, wherein the instructions comprise additional computer-readable instructions that, when executed by the at least one processor, cause the computing platform to:
determine the interrelationships in the received data based on a machine learning model, wherein the machine learning model is trained to detect patterns in known interrelationships in the repository of historical transaction data.

6. The computing platform of claim 1, wherein the instructions comprise additional computer-readable instructions that, when executed by the at least one processor, cause the computing platform to:
determine, based on the comparison with data in the repository of historical transaction data, whether the data field is associated with the customer in the distributed ledger system; and
upon a determination that the data field is not associated with the customer, identify a ledger of the distributed ledger system that needs to be updated; and
wherein providing the data field comprises providing the data field to the identified ledger.

7. The computing platform of claim 6, wherein the instructions comprise additional computer-readable instructions that, when executed by the at least one processor, cause the computing platform to:
cause, for the data field, a column to be created in the identified ledger; and
enter, in a row corresponding to the customer and in the column corresponding to the data field, a value for the data field.

8. The computing platform of claim 1, wherein the instructions comprise additional computer-readable instructions that, when executed by the at least one processor, cause the computing platform to:
detect a new ledger in the distributed ledger system;
retrieve data from the detected ledger; and
determine interrelationships in the retrieved data based on a machine learning model, wherein the machine learning model is trained to detect patterns in known interrelationships in the repository of historical transaction data.

9. The computing platform of claim 1, wherein the instructions comprise additional computer-readable instructions that, when executed by the at least one processor, cause the computing platform to:
determine, by the computing device and for the one or more identified ledgers, a format for the data field; and
wherein providing the data field comprises converting the data field to the determined format.

10. The computing platform of claim 9, wherein the format is an encrypted format, and the instructions comprise additional computer-readable instructions that, when executed by the at least one processor, cause the computing platform to:
convert the data field to the encrypted format.

11. The computing platform of claim 1, wherein the instructions comprise additional computer-readable instructions that, when executed by the at least one processor, cause the computing platform to:
train a machine learning model to identify the relationship between the data field and the customer.

12. The computing platform of claim 1, wherein the instructions to identify the relationship between the data field and the customer comprise additional computer-readable instructions that, when executed by the at least one processor, cause the computing platform to:
compare the data field to data for the customer;
determine a confidence score for the comparing; and
upon a determination that the confidence score exceeds a first threshold, associate the data field to the customer.

13. The computing platform of claim 12, wherein the instructions comprise additional computer-readable instructions that, when executed by the at least one processor, cause the computing platform to:
upon a determination that the confidence score does not exceed a second threshold, not associate the data field to the customer.

14. The computing platform of claim 1, wherein the instructions comprise additional computer-readable instructions that, when executed by the at least one processor, cause the computing platform to:
identify the one or more ledgers of the distributed ledger system by applying a statistical decision making algorithm.

15. A method, comprising:
at a computing platform comprising at least one processor, and memory:
retrieving, by a computing device, data from one or more ledgers of a distributed ledger system;
determining, by the computing device, interrelationships in the retrieved data;
storing, by the computing device, the interrelationships in a repository of historical transaction data;
retrieving, by the computing device and from one or more transaction processing systems, a data field associated with a transaction performed by a customer;
identifying, by the computing device and based on the repository of historical transaction data, a relationship between the data field and the customer;
identifying, by the computing device and based on the relationship and the data field, a ledger of the one or more ledgers of the distributed ledger system to be potentially updated with the data field;
determining, by the computing device and based on a comparison with data in the repository of historical transaction data, whether the ledger is to be updated with the data field;
based upon a determination that the ledger is to be updated, providing, by the computing device and to the ledger, the data field; and
causing, by the computing device, ledger to be updated.

16. The method of claim 15, further comprising:
determining the interrelationships in the retrieved data based on a machine learning model, wherein the machine learning model is trained to detect patterns in known interrelationships in the repository of historical transaction data.

17. The method of claim 15, further comprising:
receiving data from the one or more transaction processing systems;
determining second interrelationships in the received data; and
storing the second interrelationships in the repository of historical transaction data.

18. The method of claim 15, further comprising:
determining, based on the comparison with data in the repository of historical transaction data, whether the data field is associated with the customer in the distributed ledger system; and
upon a determination that the data field is not associated with the customer, identifying a ledger of the distributed ledger system that needs to be updated; and
wherein providing the data field comprises providing the data field to the identified ledger.

19. The method of claim 15, further comprising:
comparing the data field to data for the customer;
determining a confidence score for the comparing; and
upon a determination that the confidence score exceeds a first threshold, associating the data field to the customer.

20. One or more non-transitory computer-readable media storing instructions that, when executed by a computing platform comprising at least one processor, and memory, cause the computing platform to:
retrieve, from one or more transaction processing systems, a data field associated with a transaction performed by a customer;
identify, based on a classifier algorithm and based on a repository of historical transaction data, a relationship between the data field and the customer;
identify, based on the relationship and the data field, one or more ledgers of a distributed ledger system to be potentially updated with the data field;
determine, based on a comparison with data in the repository of historical transaction data, whether the one or more identified ledgers are to be updated with the data field;
based upon a determination that the one or more identified ledgers are to be updated, provide, to the one or more identified ledgers, the data field; and
cause the one or more identified ledgers to be updated.
